(19) United States
(12) Patent Application Publication
(10) Pub. No.: US 2007/0200812 A1
(43) Pub. Date: Aug. 30, 2007

(54) Organic el display device

(76) Inventors: Jun Maede, Kyoto (JP); Shinichi Abe, Kyoto (JP); Masanori Fujisawa, Kyoto (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/592,143

(22) PCT Filed: Mar. 9, 2005
(86) PCT No.: PCT/JP05/04112

§ 371 Date: Sep. 8, 2006

(30) Foreign Application Priority Data
Mar. 10, 2004 (JP) 2004-066821

(51) Int. Cl. G09G 3/36

(52) U.S. Cl. 345/92

(57) ABSTRACT

[Problem]To provide an organic EL display device, which can prevent erroneous light emission of an active matrix type display panel and reduce power consumption during the display panel switching and is effective in reducing area and thickness of the organic EL display device. [Means for Resolution]An organic EL display device having a first organic EL panel of active matrix type and a second organic EL panel includes current drive circuits having output pins commonly used by the first and second organic EL panels and switch circuits for cutting drive currents of the first organic EL panel off are provided in the first organic EL panel. According to another aspect of the present invention, the organic EL display device includes a reset circuit constructed with a D/A converter circuit and a plurality of analog switches connected to the output pins. The reset circuit resets terminal voltages of organic EL elements of the organic EL panel in responsive to externally supplied data to generate analog voltages by the D/A converter circuit and output the analog voltages as reset voltages by turning the analog switches ON in a reset period.

### TECHNICAL FIELD

The present invention relates to an organic EL display device and, in particular, to an organic EL display device, which has a main display and a sub display, can reduce power consumption during a switching of display from one of the displays to the other and is effective in reducing area and thickness thereof.

### BACKGROUND ART

Because of possibility of high luminance display due to spontaneous light emission, the organic EL display device is currently attracting people's attention as the next generation display device, which is suitable for use in a display having a small display screen and is to be mounted on a portable telephone set, a PHS, a DVD player and a PDA (personal digital assistance), etc.

In the portable telephone set, etc., a main display and a sub display are usually arranged back to back in a flap cover of the portable telephone set so that the sub display, which is arranged on an outside of the flat cover, displays information necessary for the sub display in a state where the flap cover is closed and displays operational information such as menu, etc., on the main display provided on an inside of the flap cover in a state where the flap cover is opened.

In such case, it is usual that the main display is a high resolution color display and the sub display is a monochromic display having smaller screen than that of the main display. Particularly, the sub display of the portable telephone set displays time and a call image when there is a call.

Drivers for the main and sub displays are different in specification from each other and are usually provided discretely since they are on-chipped on a display substrate.

A current drive circuit of an organic EL display panel of either active matrix type or passive matrix type includes current source drive circuits such as output circuits taking in the form of current mirror circuits provided correspondingly to terminal pins of the organic EL display panel.

In the current drive circuit of the active matrix type organic EL panel, pixel circuits are provided correspondingly to respective display cells (pixels). Each pixel circuit includes a capacitor and drives transistors according to a voltage stored in the capacitor to current-drive an organic EL (referred to as “OEL”, hereinafter) element through the transistor.

On the other hand, in the current drive circuits of the passive matrix type organic EL display panel, anodes of OEL elements arranged in matrix are connected to output pins of the current source drive circuits through column pins, respectively, to drive the OEL elements by the respective current source drive circuits.

Incidentally, JP2003-234655A (assigned to the assignee of this application, Patent Reference 1) discloses D/A converter circuits provided correspondingly to column pins of an organic EL display panel as a drive circuit thereof. The disclosed D/A converter circuits generate drive currents or a base currents on which drive currents are generated.

currents, on which the drive currents are generated, correspondingly to the column pins by converting digital display data supplied thereto into analog data according to a reference drive current also supplied to the D/A converter circuits.
Patent Reference 1: JP2003-234655A

### DISCLOSURE OF THE INVENTION

Problems that the Invention is to Solve

The main display and the sub display are provided with driver ICs's each of which includes current source drive circuits, correspondingly to data lines or column pins. Therefore, an area of a compact electronic device such as a portable telephone set, in which the main display and the sub display are mounted, becomes wider. This fact is an obstacle to make a portion of the portable telephone set, for example, a flap cover of the telephone set, thinner.

Further, when one of the main display and the sub display is used, drive current sources of the other display are not completely turned OFF. That is, they are set to standby states. Therefore, power consumption is increased. In addition thereto, when the display panel switching between the main and sub displays is performed, the setting of the one display to the standby state and the resetting of the other display from the standby state are performed. Therefore, a transient current due to the switching makes power consumption larger.

In view of this fact, it might be considered that driver IC's are commonly used by both the main display and the sub display. In such case, however, it is necessary to double the number of output pins to be connected to the column pins and to switch the output pins within the driver IC's. This is very difficult due to the increased number of output pins. Further, since switches corresponding in number to the output pins are to be provided, there is another problem of considerable increase of the circuit size. In addition, when brightness of display of one display panel is different from that of the other display panel and the display panels commonly use the output pins, there is another problem that voltages at the output pins may be jumped up.

Even in a case where the switching of display is performed as mentioned above in the active matrix type organic EL display panel, drive current values are usually written in capacitors, each being several hundred pF, of the pixel circuits by charging the capacitors of the pixel circuits with current in a range from 0.1 μA to 10 μA. Therefore, there is a problem that the capacitor of the pixel circuit is written erroneously by the transient current generated by the switching of organic EL panel, causing the corresponding OEL element to emit light erroneously.

The present invention was made to solve the above mentioned problems inherent to the prior art and an object of the present invention is to provide an organic EL display device, which can prevent erroneous light emission of an active matrix type display panel at a switching time from one display panel to the other display panel and reduce power consumption during the display panel switching and is effective in reducing area and thickness of the organic EL display device.

Another object of the present invention is to provide an organic EL display device, which has switchable two display panels having different reset voltages and can reduce power consumption during a switching of display from one display panel to the other display panel and is effective in reducing area and thickness of the organic EL display device.

Means for Solving the Problems

In order to achieve the objects, the organic EL display device according to an aspect of the present invention includes a first organic EL panel of the active matrix type, a second organic EL panel of the passive or active matrix type, a plurality of current drive circuits having output pins commonly connected to data lines or column pins of both the first and second organic EL display panels, the current drive circuits outputting drive currents for driving OEL elements to the data lines or the column pins connected to the output pins, a plurality of first switch circuits provided in connecting lines to the data lines or the column pins of the first organic EL display panel, for cutting the drive currents off, respectively, and a drive current cutoff circuit provided within the second organic EL panel or downstream of the OEL elements of the second organic EL panel, for cutting the drive currents supplied to the second organic EL panel off, wherein the first switch circuits are turned OFF when the second organic EL panel is driven according to a selection signal, to cut the drive currents to the first organic EL panel off and output the drive currents to the data lines or the column pins of the second organic EL panel and the drive current cutoff circuit cuts the drive currents to the second organic EL panel and the first switch circuits are turned ON when the first organic EL panel is driven according to the selection signal, to output the drive currents to the data lines or the column pins of the first organic EL panel.

The organic EL display device according to another aspect of the present invention includes a first organic EL panel, a second organic EL panel having a reset voltage different from that of the first organic EL panel, a plurality of current drive circuits having output pins commonly connected to data lines or column pins of the first and second organic EL display panels, the current drive circuits outputting drive currents for driving OEL elements to the data lines or the column pins connected to the output pins, a reset circuit having D/A converter circuit and connected to the output pins through analog switches, wherein, in response to data corresponding to a difference in the reset voltage between the first and second organic EL panels and supplied externally of the reset circuit, the D/A converter circuit of the reset circuit generates an analog voltage and output the analog voltage as the reset voltage by turning the analog switches ON in a reset period.

Advantage of the Invention

As mentioned above, according to the first aspect of the present invention, the current drive circuits, which commonly use the output pins for both the first organic EL panel and the second organic EL panel, are provided and the switch circuits for cutting the drive currents off are provided within the first organic EL panel of the active matrix type. Therefore, there is no need of providing the current drive circuits for each of the first and second organic EL panels. Consequently, there is no need of keeping the current drive circuits on the side, which is not selected, in the standby state and, so, it is possible to reduce power consumption correspondingly.

In addition, since, in the first aspect, the drive currents for the first organic EL panel of the active matrix type are cut off by the switch circuits provided in the connecting lines for connecting to the respective data lines or the column pins when the switching to the second organic EL panel is made, the erroneous light emission of the first organic EL panel of the active matrix type due to transient currents for the switching time is prevented. Further, since the first switch circuits of the first organic EL panel, which is not operated, are in the OFF state, the erroneous light emission is prevented even after the panel switching.

Further, it is enough to operate either one of the first and second organic EL panels. Since, therefore, the switching between these organic EL panels is performed on the side of the first organic EL panel of active matrix type, which is a load of the current drive circuits, which commonly use the output pins, the transient current is restricted correspondingly. Assuming that the cutoff circuits of the drive currents of the second organic EL panel constitute a vertical scan circuit, the switching between the first and second organic EL panels is performed on the downstream side of the load circuits of the current drive circuits. Therefore, the transient current is further restricted. In addition, when the display switching is performed by switching the vertical side scan circuit between operation and non-operation states, there is no need of providing switches correspondingly to the output pins for the second organic EL panel and, so, there is no increase of circuit size.

As a result, according to the first aspect, it is possible to provide the organic EL display device, which can prevent erroneous light emission of an active matrix type display at a switching time between the main display and the sub display and reduce power consumption during the display panel switching and is effective in reducing area and thickness of the organic EL display device.

On the other hand, according to the second aspect, the first and second organic EL panels, which are to be switched, have different reset voltages in such case as the organic EL display panels are of active matrix and passive matrix types, respectively, and are common loads of the output pins of the current drive circuits. Therefore, by providing the D/A converter circuits and the analog switches, it is possible to generate the different reset voltages by using a common circuit. That is, it is possible that the reset circuits for the two display panels can be used commonly. Therefore, a total area of the reset circuit in the driver IC's can be reduced.

As a result, it is possible to obtain an organic EL display device, which can reduce power consumption in the display switching time and is effective in reducing area and thickness of the organic EL display device.

Best Mode for Carrying Out of the Invention

FIG. 1 is a block circuit diagram of an embodiment of an organic EL display device of the present invention, in which a current drive circuit is commonly used by organic EL panels of the active matrix type and of the passive matrix type, FIG. 2 is a block circuit diagram of a pixel circuit of the active matrix type organic EL panel shown in FIG. 1, FIG. 3 is a block circuit diagram of another embodiment of the organic EL display device of the present invention, in which a current drive circuit is commonly used by two active matrix type organic EL panels and FIG. 4 is a block circuit diagram of a further embodiment of the organic EL display device of the present invention, in which a current drive circuit is commonly used by two active matrix type organic EL panels.

In FIG. 1, a reference numeral 1 depicts an organic EL display device including an active matrix type organic EL panel 2 and a passive matrix type organic EL panel 3.

A reference numeral 4 depicts a current driver IC (referred to as “driver”, hereinafter), which is provided commonly for the organic EL panels 2 and 3 and includes column side output stage current sources 40a, . . . 40i, . . . 40n, row side scan circuits 41 and 42, an inverter 43 and a reset circuit 44.

The driver 4 selectively drives either one of the organic EL panels 2 and 3 according to high (“H”) and low (“L”) levels of a display selection signal (referred to as “selection signal”, hereinafter) SEL supplied from a control circuit 12 through an input terminal 4a. According to this selection signal, the one organic EL panel becomes a display state and the other organic EL panel becomes a non-display state.

For example, a control circuit 12 generates the selection signal SEL in “H” level when a display switch 11 is turned ON. When the display switch 11 is in OFF state or is turned OFF, the control circuit 12 generates the selection signal SEL in “L” level. Incidentally, the display switch 11 becomes ON when, for example, a cover of a portable telephone set having the display device 1 therein is closed. The selection signal SEL is also supplied to an MPU 14.

The active matrix type organic EL panel 2 is mounted on a rear surface side of the flap cover of the portable telephone set, which houses the display device 1 as a main display and the passive matrix type organic EL panel 3 is mounted on a front surface side of the flap cover as a sub display. Thus, the organic EL panels 2 and 3 are mounted in a casing of the flap cover in a back to back relation and output pins 5a, 5i, 5n of the driver 4 are commonly connected to column lines (column pins) or data lines of the organic EL panels 2 and 3.

Incidentally, in the case where the organic EL panels are arranged back to back as described above and are driven selectively, the horizontal scan direction of the organic EL panel 2 becomes opposite to that of the organic EL panel 3. Therefore, display data corresponding to one horizontal scan line for the organic EL panels have to be set in a direction opposite to a setting direction of data corresponding to one horizontal scan line for the other organic EL panel. In such case, it is usual to use a bidirectional shift register. However, it is not directly related to the present invention, detailed explanation thereof is omitted.

The number of pixels of the organic EL panel 2 (main display) is usually larger than that of the organic EL panel (sub display). Therefore, another driver having a construction similar to that of the driver 4 is provided for the organic EL panel 2. Since the additional driver is not provided in the sub display, it is not shown in the drawings. By providing the additional driver to the organic EL panel 2, it is possible to increase the number of output pins and a display area of the organic EL panel 2 compared with those of the organic EL panel 3.

Switch circuits SP, that is, SPa, . . . SPi, . . . SPn, are provided correspondingly to respective data lines X, that is, data lines Xa, . . . Xi, . . . Xn, . . . of the organic EL panel 2 for one horizontal scan line. A plurality of output pins 5, that is, the pins 5a, . . . 5i, . . . 5n, of output stage current sources 40, that is, current sources 40a, . . . 40i , . . . 40n, are connected to the data lines X through data line terminal pins of the organic EL panel 2 and the switch circuits SP, respectively. Therefore, when the switch circuits SP are in ON state, drive currents are supplied to the pixel circuits 6 through the output pins 5 of the current sources 40, respectively. Each of the switch circuits SP is constructed with P channel MOS transistors Tₚ having gates commonly connected to an output pin 4d of the driver 4, so that the P channel transistors Tₚ are ON/OFF controlled according to a signal in “L” or “H” level at the output pin 4d.

The pixel circuit 6 is provided every cross point of an X and Y matrix wiring (data lines X and scan lines Y1 , Y2, ). The pixel circuits 6, each of which is constructed with four transistors and an OEL element 6a as shown in FIG. 2, are provided correspondingly to the display pixels of the organic EL panel 2 and connected to the output pins 5 of the driver 4 through the data lines X and the switch circuits SP, respectively.

As shown in FIG. 2, the pixel circuits 6 are provided at every cross point between the data lines X and the scan lines Y (Y1 and Y2) and each pixel circuit 6 includes P channel MOS transistors TP1 and TP2 having gates connected to the scan line Y of the cross point and drains connected to the data line X of the cross point. Further, the pixel circuit 6 includes P channel MOS transistors TP3 and TP4, which are connected in series, and one of the OEL elements 6a is current-driven by these transistors. A capacitor C is connected between a source and a gate of the transistor TP3 for driving the pixel.

A source of the transistor TP1 is connected to the gate of the transistor TP3 and a source of the transistor TP2 is connected to a drain of the transistor TP3. Thus, when the transistors TP1 and TP2 are turned ON, the gate and the drain of the transistor TP3 are diode-connected, so that the drive current flows through the transistor TP3 and a voltage corresponding to the drive current is stored in the capacitor C with high precision.

The source of the transistor TP3 is connected to a power source line +Vcc and the drain thereof is connected to the source of the transistor TP4. A drain of the transistor TP4 is connected to an anode of the OEL element 6a. A cathode of the OEL element 6a is grounded through a switch 41c provided in a scan circuit 41b of the row side scan circuit 41, as shown in FIG. 2.

The gates of the transistors TP1 and TP2 are connected to the scan line Y1 of the row side scan circuit 41 and the gate of the transistor TP4 is connected to the scan line Y2 of the row side scan circuit 41. The row side scan circuit 41 is constructed with a write control circuit 41a and the scan circuit 41b, as shown in FIG. 2. The scan lines Y1 and Y2 constitute one horizontal scan line (see FIG. 1) and levels the scan lines Y1 and Y2 corresponding to a line to be vertically scanned by the write control circuit 41a are controlled to “H” or “L” level.

Under control of the write control circuit 41a, the scan circuit 41b performs a vertical scan by ON/OFF controlling the switch circuit 41c of the scan circuit 41b provided between the vertical scan line 7 and ground GND such that only the scan line 7 to be scanned is turned ON. Incidentally, cathodes of the OEL elements 6a for one horizontal line are connected to the scan line 7 arranged vertically.

Incidentally, it is usual that a plurality of drivers 4 on the side of the organic EL panel 2 generate drive currents for the one horizontal line. Therefore, the scan circuit 41b is provided for a plurality of the drivers 4.

Now, the passive matrix type organic EL panel 3 shown in FIG. 1 will be described. The output pins 5 of the respective output stage current sources 40 are further connected to a plurality of column lines CL, that is, column lines CLa, CLi, CLn, of the organic EL panel 3 through column pins, respectively. An OEL element 3a is provided at each of cross points between the column lines CL and the row lines 8 (vertical scan lines), respectively. Anodes of the OEL elements 3a are directly connected to the respective column lines CL and cathodes of the OEL elements 3a arranged horizontally are vertically. When a certain row line 8 becomes a subject of vertical scan by the row side scan circuit 42, the certain row line is grounded.

The row side scan circuit 42 is constructed with a shift register and a CMOS output circuit, etc., and the CMOS output circuit is provided every row line 8 (every horizontal line) in vertical scan direction of the organic EL panel 3. The CMOS output circuits are sequentially driven by the shift register to ground the row line 8, that is, one horizontal scan line, which is the subject of vertical scan. Therefore, the row side scan circuit 42 discharges drive current for one horizontal scan line from the output pins 5.

The vertical scan of the row side scan circuits 41 and 42 are performed according to a timing signal supplied from the control circuit 12 through the input terminal 4e.

As shown in FIG. 1, each of the output stage current sources 40, that is, the output stage current sources 40a, . . . 40i, . . . 40n, is constructed with a current mirror circuit 45, analog switches (transmission gates) 46, 47 and 48 and a D/A converter circuit 49. Correspondingly to each horizontal scan in the vertical direction performed by the row side scan circuit 41 or the row side scan circuit 42, sink or source output currents are generated and supplied to the respective output pins 5. Each D/A converter circuit 49 is constructed with a current mirror circuit. The D/A converter circuit 49 receives a reference drive current supplied to an input side transistor thereof and converts it into an analog current, which is outputted from an output side transistor of the current mirror circuit, according to a digital display data inputted thereto.

The output currents at the output pins 5 are switched between sink current and source current by a selection signal SEL inputted to the input terminal 4a. When the selection signal SEL is in “L” level, the output currents at the output pins 5 become sink currents and, when the selection signal SEL is in “H” level, the output currents become source currents. The switching between the sink current and the source current will be described in detail later.

The current mirror circuit 45 is constructed with P channel MOS transistors QP1 and QP2 and the channel width (gate width) ratio of the input side transistor QP1 and the output side transistor QP2 is 1:10.

Sources of the transistors QP1 and QP2 are connected to a power source line +Vcc of about +15V. A drain of the input side transistor QP1 is connected to a gate thereof, which is connected to a gate of the output side transistor QP2, and to the D/A converter circuit 49 through the analog switch 46.

The analog switch 47 is provided between the source and the drain of the transistor QP1 and the drain of the output side transistor QP2 is connected to the output pin 5. The analog switch 48 is provided between the output pin 5 and the output of the D/A converter circuit 49. The analog switches 47 and 48 are arranged such that the phase of the selection signal SEL supplied to these analog switches becomes opposite to the phase thereof inputted to the analog switch 46. Therefore, when the selection signal SEL is in “H” level, the analog switch 46 is in ON state and the analog switches 47 and 48 are in OFF state. When the selection signal SEL is in “L” level, the analog switch 46 is in OFF state and the analog switches 47 and 48 are in ON state.

A reset circuit 44 is constructed with a D/A converter circuit 440 and analog switches (transmission gates) 44x, that is, analog switches 44a, . . . 44i, . . . 44n, which are provided correspondingly to the output pins and connected between the output pins 5 and the D/A converter circuit 440. The D/A converter circuit 440 receives data DA from a register 13 through the input terminal 4c and generates a predetermined reset voltage (preset voltage) VR for a reset period RT. The reset voltage thus generated is outputted to the output pins 5 through the analog switches 44x, respectively. In response to a reset signal RS supplied from the control circuit 12 through an input terminal 4b, the analog switches 44x becomes ON state during the reset period RT. The reset signal RS is generated according a reset control signal or a timing control signal, which is in “H” level during the reset period RT.

The data DA from the MPU 14 is set in the register 13 according to “H” or “L” of the selection signal SEL.

Each of the row side scan circuits 41 and 42 performs the scanning upon an enable signal which is in “H” level, and the reset signal RS.

The row side scan circuit 41 receives the selection signal SEL as the enable signal through the input terminal 4a and an inverter 43. The row side scan circuit 42 receives the selection signal SEL as the enable signal, directly.

Incidentally, the scan operations of the row side scan circuits 41 and 42 are started from the reset period RT upon reception of the reset signal RS through the input terminal 4b.

When the display switch 11 is turned from ON to OFF, the row side scan circuit 41 starts, from the reset period RT of the reset signal RS, the vertical (row side) scan of the organic EL panel 2 upon reception of the “H” level enable signal, which is obtained by inverting the “L” level selection signal SEL by the inverter 43. On the other hand, since the row side scan circuit 42 of the organic EL panel 3 receives the “L” level selection signal SEL directly when the display switch 11 is turned OFF, the row side scan circuit 42 stops the vertical scan operation.

On the contrary, when the display switch 11 is turned from OFF to ON, the row side scan circuit 41 of the organic EL panel 2 receives the “L” level enable signal, which is obtained by inverting the “H” level selection signal SEL, to stop the vertical scan operation. On the other hand, when the display switch 11 is turned ON, the row side scan circuit 42 of the organic EL panel 3 starts, from the reset period RT of the reset signal RS, since it receives the “H” level selection signal SEL as the enable signal, directly.

As such, when the flap cover of the device such as a portable telephone set housing this display device 1 is closed, the selection signal SEL becomes “H” level upon which the row side scan circuit 42 of the passive matrix type organic EL panel 3 and, when the flap cover is opened, the selection signal SEL becomes “L” level and the row side scan circuit 41 of the active matrix type organic EL panel 2 is actuated.

Now, the operation of the organic EL panel 2 with the selection signal SEL will be described. When the selection signal SEL inputted to the input terminal 4a of the driver 4 is “L” level, the organic EL panel 2 is selected and the OEL elements 6a of the pixel circuit 6 for one horizontal line corresponding to the vertical scan of the scan circuit 41 are driven through the data lines or the column pins.

Describing the operation of the pixel circuit 6 in such case, the transistors TP1 and TP2 are turned ON since the scan line Y1 becomes “L” level by the row side scan. Therefore, a predetermined drive current I, which is sunk by the D/A converter circuit 49, flows from the power source line +Vcc through the transistor TP3, the capacitor C of the pixel circuit 6, the transistors TP1 and TP2, the data line X, the switch circuit SP and the output pin 5 to the D/A converter circuit 49 and the capacitor C is written with the voltage value corresponding to the drive current I. When the write of the drive current I in the capacitor C is completed, the scan line Y1 becomes “H” level and the transistors TP1 and TP2 are turned OFF. And then, the scan line Y2 becomes “L” level and the transistor TP4 is turned ON, the transistors TP3 and TP2 are kept ON and the drive current I corresponding to the voltage value stored in the capacitor C is supplied to the anode of the OEL element 6a for the display period. Incidentally, since, in this case, the scan line Y1 is “H” level, the transistors TP1 and TP2 are OFF.

In this manner, the OEL elements 6a of one horizontal line to be vertically scanned are driven according to values of drive current supplied through the data lines X corresponding to the horizontal line, respectively.

At a time when the drive period of the OEL elements 6a by the transistors TP3 and TP4 is ended, the operation enters into the reset period RT, the scan line Y2 and the scan line Y1 become “H” and “L” levels, respectively. Therefore, the transistor TP4 is turned OFF and the transistors TP1 and TP2 are turned ON.

On the other hand, the analog switches 44x are turned ON by the reset signal RS, so that the reset voltage VR of the D/A converter circuit 440 is added to the output pins 5 and the capacitors C of the pixel circuits 6 for one horizontal line are reset to the predetermined reset voltage VR through the transistors TP1 and TP2, which are in ON state. The reset voltage VR in this case is set to a value in the vicinity of the power source voltage +Vcc according to the data DA set in the register 13.

Incidentally, in the reset period RT, the switch circuit 41c is turned ON by the row side scan circuit 41 to ground the cathodes of the OEL elements 6a for one horizontal line to be vertically scanned.

Such operation is performed correspondingly to the vertical scan by the row side scan circuit 41 to thereby perform the display of the organic EL panel 2.

The switching operation of the output stage current source 40 between the sink current and the source current and the switching operation of the organic EL panels will be described with reference to FIG. 1.

In response to the “L” level selection signal SEL inputted to the input terminal 4a, the analog switches 46 of the output stage current sources 40 are turned OFF and the analog switches 47 and 48 thereof are turned ON.

When the transistors 47 are turned ON, the transistors QP1 and QP2 become OFF. Therefore, the operation of the current mirror circuit 45 is stopped and the transistors QP2 are separated from the output pins 5, respectively. When the transistors 48 are turned ON, the outputs of the D/A converters 49 are connected to the output pins 5, so that the output pins 5 output sink currents, each having the value I, from the D/A converter circuits 49 as the drive current sources, respectively.

Further, the “L” level selection signal SEL inputted to the input terminal 4a is supplied to the gates of the transistors TP of the switch circuits SP of the organic EL panel 2 through the output pins 4d, as it is. Thus, the transistors TP of the organic EL panel 2 are turned ON.

Further, when the “L” level selection signal SEL is inputted to the input terminal 4a of the driver 4, the “H” level output of the inverter 43 is supplied to the row side scan circuit 41 to perform the vertical scan. At the same time, the “L” level selection signal SEL is inputted to the MPU 14, upon which the MPU 14 sends the data DA for generating the reset voltage VR for the active matrix type organic EL panel 2 to the register 13. Therefore, the capacitors C of the pixel circuits 6 are reset with the predetermined reset voltage VR through the output pins 5 in the reset period RT.

As a result, the capacitors C of the pixel circuits 6 connected to the currently scanned horizontal line are written with the voltage values through the data lines X of the active matrix type organic EL panel 2, according to the vertical scan performed by the row side scan circuit 41, and then the OEL elements 6a for the horizontal line are driven by the drive currents from the capacitors C.

Incidentally, at this time, the “L” level selection signal SEL of the input terminal 4a is supplied to the row side scan circuit 42, so that the operation of the row side scan circuit 42 is stopped. Further, since sink drive currents are outputted from the output pins 5 on the side of the organic EL panel 3, the OEL elements 3a are reverse-biased and erroneous light emission thereof is prevented.

The operation of the organic EL panel 3 when the “H” level selection signal SEL is inputted to the input terminal 4a will be described. Upon the reception of the “H” level signal, the analog switches 46 of the output stage current sources 40 are turned ON and the analog switches 47 and 48 are turned OFF.

When the analog switch 47 is turned OFF, the current mirror circuit 45 composed of the transistors QP1 and QP2 becomes operative. In this case, the drain of the transistor QP2 is connected to the corresponding output pin 5. When the analog switch 46 is turned OFF, the D/A converter circuit 49 is separated from the output pin 5. When the analog switch 46 is turned ON, the drain of the transistor QP1 is connected to the output of the D/A converter circuit 49, so that the current mirror circuit 45 is driven with the output current I of the D/A converter circuit 49. Thus, the drive current I 10 is discharged from the transistor QP2 to the corresponding output pin 5.

The “H” level selection signal SEL inputted to the input terminal 4a is supplied to the row side scan circuit 42 to actuate the latter circuit. Further, the “H” level selection signal SEL is supplied to the gates of the transistors TP of the switch circuits SP through the output pin 4d. Thus, the transistors TP are turned OFF.

As a result, the drive currents from the output pins 5 to the data lines X of the organic EL panel 2 are blocked. Since, therefore, the drive currents of the active matrix type organic EL panel 2 are blocked by the switch circuits SP provided correspondingly to the data lines or the column pins when the switching of organic EL panel from the active matrix type organic EL panel 2 to the passive type organic EL panel 3 is performed, the erroneous light emission of the active matrix type organic EL panel 2 due to transient current at the panel switching time is prevented. Further, since the switch circuits SP of the active matrix type organic EL panel 2, which is not driven, are in OFF state, the erroneous light emission thereof is prevented even after the panel switching.

Now, the operation of the organic EL panel 3 with the selection signal SEL will be described.

Upon reception of the “H” level selection signal SEL inputted to the input terminal 4a, the row side scan circuit 42 is actuated and the line scan in vertical direction of the organic EL panel 3 is performed. When one horizontal line to be vertically scanned is grounded, the OEL elements 3a connected between the horizontal line in the vertical scan direction to be scanned and the column lines CL are driven by the source currents from the current mirror circuits 45.

Incidentally, since, in this case, the “H” level selection signal SEL inputted to the input terminal 4a is supplied to the row side scan circuit 41 through the inverter 43 as the “L” level signal, the row side scan circuit 41 is not operated.

Therefore, either the organic EL panel 2 or the organic EL panel 3 is selected and the selected organic EL panel performs the display operation according to the ON/OFF operation of the display switch 11. In other words, according to the open/close operation of the flap cover of such as portable telephone set housing the display device 1, either the organic EL panel 2 or the organic EL panel 3 is selected and performs the display operation.

Describing the resetting of the organic EL panel 3, the MPU 14 receives the “H” level selection signal SEL inputted to the input terminal 4a and sends the data DA for generating a reset voltage VR of the passive matrix type organic EL panel 3 to the register 13. The OEL elements 3a of the passive matrix type organic EL panel 3 are reset with the predetermined reset voltage VR supplied through the output pins 5 in the reset period RT.

Incidentally, assuming that the timing control signal is a signal for sectioning the display period to the display period corresponding to the scan period for one horizontal line and the reset period (scan switching period in vertical direction) corresponding to the retrace period, it is usual, in driving the passive matrix type organic EL panel, that the timing control signal is identical to the reset control signal and, therefore, the reset control signal is used as the timing control signal too. Further, the reset signal RS is usually assigned to not a whole but a portion of the reset period RT corresponding to the retrace period.

Since it is necessary in driving the active matrix type organic EL panel to provide the write period for the writing of voltage value in the capacitors C of the pixel circuits 6, the reset control signal or a reset signal is usually generated independently from the timing control signal. In such case, the reset period RT of the reset control signal is assigned for not a whole but a portion of the reset period RT corresponding to the retrace period. Therefore, the write of voltage values in the capacitors C of the pixel circuits 6 is started within the reset period corresponding to the retrace period, at a time when the resetting of the capacitors C of the pixel circuits 6 is completed.

Therefore, the switching operation between the organic EL panel 2 and the organic EL panel 3 and the start of operation of the selected organic EL panel may be done according to not the reset control signal but the reset signal or the timing control signal. In such case, it is possible to start the operation of the selected organic EL panel with a timing of the start of the reset period corresponding to the retrace period.

When the current drive by the output stage current sources 40 is stopped, the operation of the row side scan circuits 42 of the organic EL panel 3 is stopped. Therefore, the scan circuit 42 in this embodiment is the drive current cut-off circuit provided downstream of the organic EL panel 3 as the load circuit.

Further, since the capacitors C store the drive current values in the active matrix type organic EL panel, the OEL elements 6a thereof are grounded through the switch circuits 41c of the scan circuits 41b of the pixel circuits in this embodiment. Therefore, although the vertical scan lines for one horizontal line determined by the vertical scanning is sequentially driven in this embodiment, it may be possible to drive the whole display screen at once by turning the switch circuits 41a ON after the drive current values for one display screen are stored in the capacitors C.

When color display screens of R, G and B are driven time-divisionally, it is enough to provide the switch circuit 41a for each of R, G and B display screens.

FIG. 3 is a block circuit diagram of an organic EL display device 10 according to another embodiment of the present invention, in which a current drive circuit is commonly used by two active matrix type organic EL panels.

The organic EL display device 10 is similar to the organic EL display device 1 shown in FIG. 1 except that, instead of the passive matrix type organic EL panel 3, an active matrix type organic EL panel 20, which is similar to the active matrix type organic EL panel 2 shown in FIG. 1, is used. Therefore, the organic EL display device 10 does not include a row side scan circuit such as the row side scan circuit 42. The organic EL display panels 2 and 20 are switched and driven by a row side scan circuit 41 of the organic EL display panel 10 through a multiplexer 15.

In this case, since it is enough for output stage current sources to generate sink currents for both of the organic EL panel 2 and the organic EL panel 20, the output stage current sources include only D/A converter circuits 49 as shown in FIG. 3. Outputs of these D/A converter circuits are connected to respective output pins 5 of the driver 4.

In response to a “H” level selection signal SEL inputted to an input terminal 4a, the multiplexer 15 switches a vertical scan output thereof from the organic EL panel 2 to the organic EL panel 20.

Incidentally, in this embodiment, an output pin 4f for externally outputting an output of an inverter 43 is provided in the driver 4. The output pin 4f is connected to gates of transistors TP of respective switch circuits SP of the organic EL panel 20. As a result, drive currents of the organic EL panel 2 and the organic EL panel 3 are blocked alternatively. Sink drive currents I are supplied to the organic EL panel, whose drive currents are not blocked currently, from the output pins 5 connected to the D/A converter circuits 49.

In concrete, when the “L” level selection signal SEL inputted to the input terminal 4a, the “L” level signal is supplied to the gates of the transistors TP of the switch circuits SP of the organic EL panel 2 through the output pins 4d to turn these transistors ON. Thus, in response to the “L” level selection signal SEL, the row side scan circuit 41 selects the organic EL panel 2 through the multiplexer 15 and performs the vertical scan of the organic EL panel 2. Therefore, the pixel circuits 6 of the organic EL panel 2 are driven. In this case, the transistors TP of the switch circuits SP on the side of the organic EL panel 20 are in OFF state by “H” level signals supplied to the gates of the these transistors through the output pin 4f.

On the other hand, when a “H” level selection signal SEL is inputted to the input terminal 4a, the “L” level signal is supplied to the gates of the transistors TP of the switch circuits SP of the organic EL panel 20 through the output pin 4f, so that these transistors are turned ON and the row side scan circuit 41 performs the vertical scan on the side of the organic EL panel 20 selected by the multiplexer 15. Therefore, the pixel circuits 6 of the organic EL panel 20 are driven. At this time, the transistors TP of the switch circuits SP on the side of the organic EL panel 2 are in OFF state by “H” level signals supplied to the gates of the these transistors through the output pin 4d.

As a result, either the organic EL panel 2 or the organic EL panel 20 performs the display operation selectively according to the ON/OFF operation of the display switch 11.

Since, in this case, values of the reset voltages VR of the organic EL panels 2 and 20 are identical, it is not always necessary to convert the reset voltage by the D/A converter circuit 440 and a constant voltage circuit constructed with a Zener diode, etc., may be used as the reset voltage generator.

FIG. 4 is a block circuit diagram of an organic EL display device according to a further embodiment of the present invention, in which a current drive circuit is commonly used by two active matrix type organic EL panels.

In FIG. 4, the organic EL panel 20 shown in FIG. 3 is replaced by an organic EL panel 2a having pixel circuits 60, which are driven by current sources similarly to the organic EL panel 3 shown in FIG. 1.

The pixel circuit 60 includes N channel MOS transistors instead of the P channel MOS transistors TP1 to TP6 of the pixel circuit 6 shown in FIG. 3 and each OEL element 6a is inserted between the power source line +Vcc and a drain of the N channel transistor corresponding in position to the P channel transistor TP3 in FIG. 2.

Further, in FIG. 4, the switch circuits SP each constructed with the P channel MOS transistor TP in FIG. 3 are replaced by switch circuits SN, that is, switch circuits SNI, SNi, SNn, each constructed with an N channel MOS transistor.

Further, inverters are provided in respective scan lines Y1 and Y2 of the organic EL panel 2a.

Incidentally, in this embodiment, output stage current sources are the same as the output stage current sources 40, that is, 40a, . . . 40i, . . . 40n, shown in FIG. 1 and a switching between current source drive and current sink drive according to the level, “H” or “L”, of the selection signal SEL as in the case shown in FIG. 1. It should be noted in this embodiment that the channel width (gate width) ratio of the input side transistor QP1 and the output side transistor QP2 of the current mirror circuit 45 is 1:1.

Since an overall operation of the embodiment shown in FIG. 4 is not substantially different from the embodiment shown in FIG. 1 or FIG. 3, detailed description thereof is omitted.

In the described embodiments, the switch circuits SP are provided correspondingly to the data lines X in the active matrix type organic EL panel 2, respectively. Similarly, it may be possible to provide the switch circuits SP correspondingly to the respective column lines CL in the passive matrix type organic EL panel 3 to thereby cut off the drive currents of the output stage current sources 40 by turning the switch circuits SP OFF in the case where the organic EL panel 3 is selectively made non-display state.

In the described embodiments, the terminal pins of the organic EL panel (main display) and the organic EL panel (sub display) are assigned to the respective output pins of the driver 4. However, the present invention can be applied to a case where the number of the terminal pins of the organic EL panel 3, which is the sub display, is smaller than the number of the terminal pins of the organic EL panel 2, which is the main display. In such case, it is enough to set display data “O” in the D/A converter circuits 49 corresponding to the output pins, which do not require current outputs, when the organic EL panel 3 is driven. By doing so, there is no output current generated for the output pins.

Although the display switching is performed according to ON/OFF switching of the display switch 11, it is not always necessary to perform the switching in synchronism with the ON/OFF switching of the display switch 11. For example, when the display switch 11 is ON or OFF and the organic ET panel, which is in the display period and its display is to be stopped by the display switch, the selection signal SEL may be generated such that the display switching is performed when the organic EL panel enters into the reset period RT according to the reset signal RS. This can be easily realized by, for example, logical product of the output of the display switch and the reset signal RS.

Incidentally, it is preferable that the operation of the vertical scan circuit of either one of the first and second organic EL panels, which is driven (or performs the display) according to the selection signal, is started after the operation of the vertical scan circuit of the other organic EL panel, whose drive is stopped (or display is stopped), is stopped. The stoppage of operation in such case is not limited to a temporary stopping of the scan operation or to a standby state. The operation stoppage may be a stoppage of this circuit itself.

### INDUSTRIAL APPLICABILITY

In the embodiments described hereinbefore, the display switch of the display device 1 housed in the portable telephone set, etc., is a switch, which is turned ON by the cover of the telephone set when the latter is closed. It may be a switch, which is turned OFF when the cover is closed. In the latter case, the levels “H” and “L” of the selection signal are reversed.

Incidentally, the levels “H” and “L” of the selection signal SEL are a mere example. Since the logic can be easily reversed by such as inverter, it is possible to perform the selection operation by using the reversed logic signals. Further, the display switch is not limited to such as a push button switch. For example, it may be an optical sensor type switch, which generates a detection signal upon light when the flap cover of the display device is opened, or other sensors for detecting the display switching. Therefore, it should be noted that the switch or the switch circuit in each of the embodiments may include a sensor.

Further, although the described embodiments are constructed with MOS FET's mainly, it is possible to construct the display device with bipolar transistors mainly. Further, in the described embodiments, the N channel type (or npn type) transistors may be replaced by P channel type (or pnp type) transistors and the P channel type (or pnp type) transistors may be replaced by N channel type (or npn type) transistors. In such case, the power source voltage is usually negative and the transistors provided upstream side are shifted to downstream side.

### BRIEF DESCRIPTION OF THE DRAWINGS

FIG. 1 is a block circuit diagram of an embodiment of an organic EL display device of the present invention, in which a current drive circuit is commonly used by organic EL panels of the active matrix type and of the passive matrix type.

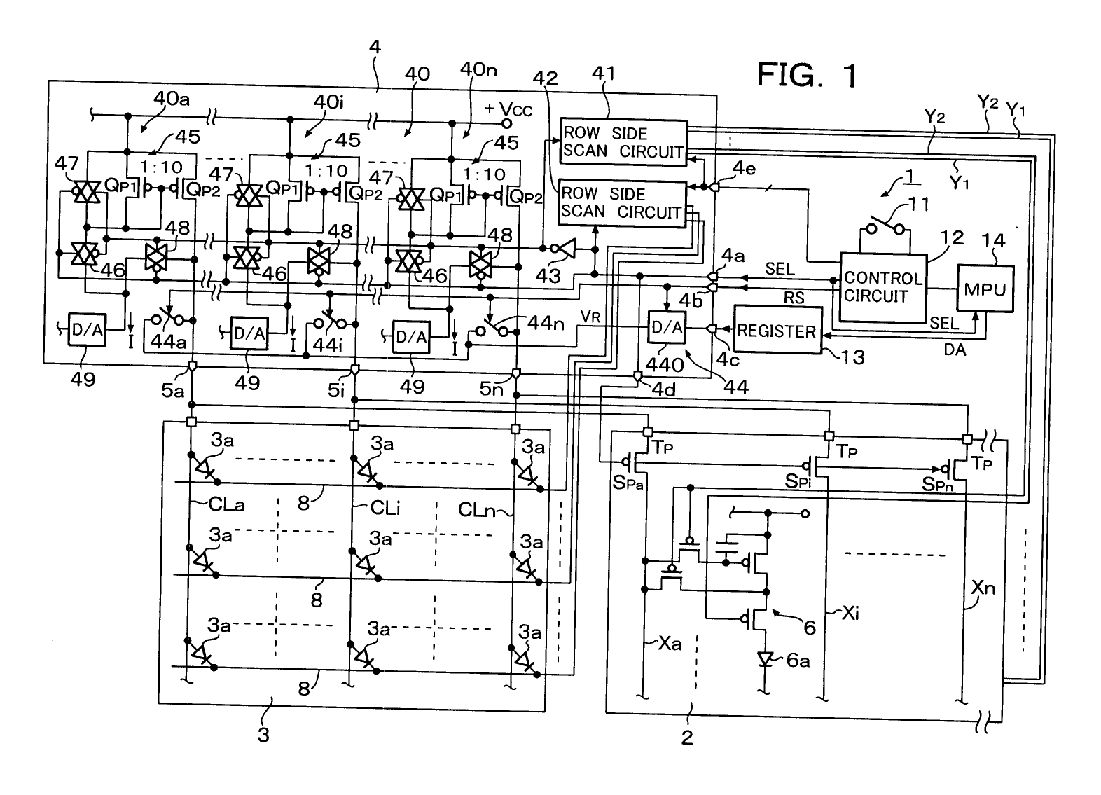

FIG. 2 is a block circuit diagram of one of pixel circuits of the active matrix type organic EL panel shown in FIG. 1.

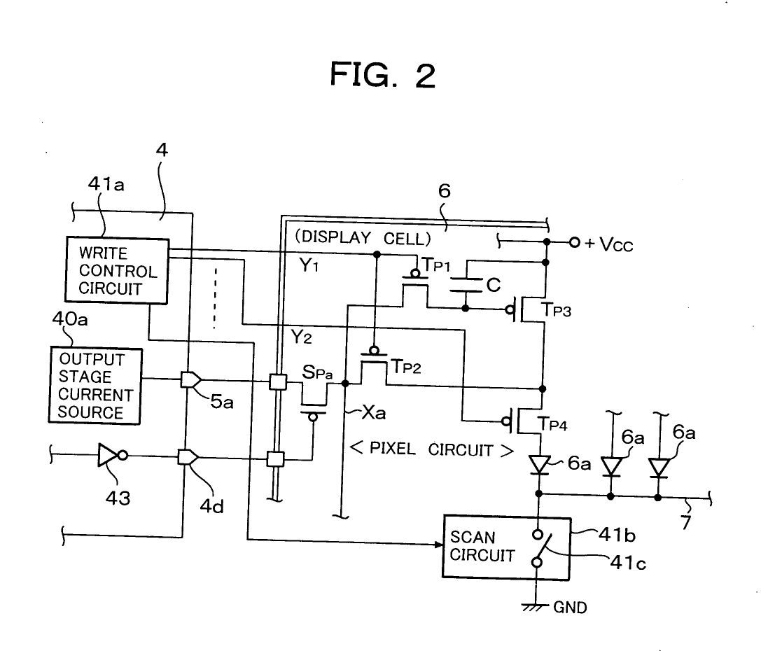

FIG. 3 is a block circuit diagram of another embodiment of the organic EL display device of the present invention, in which a current drive circuit is commonly used by two active matrix type organic EL panels.

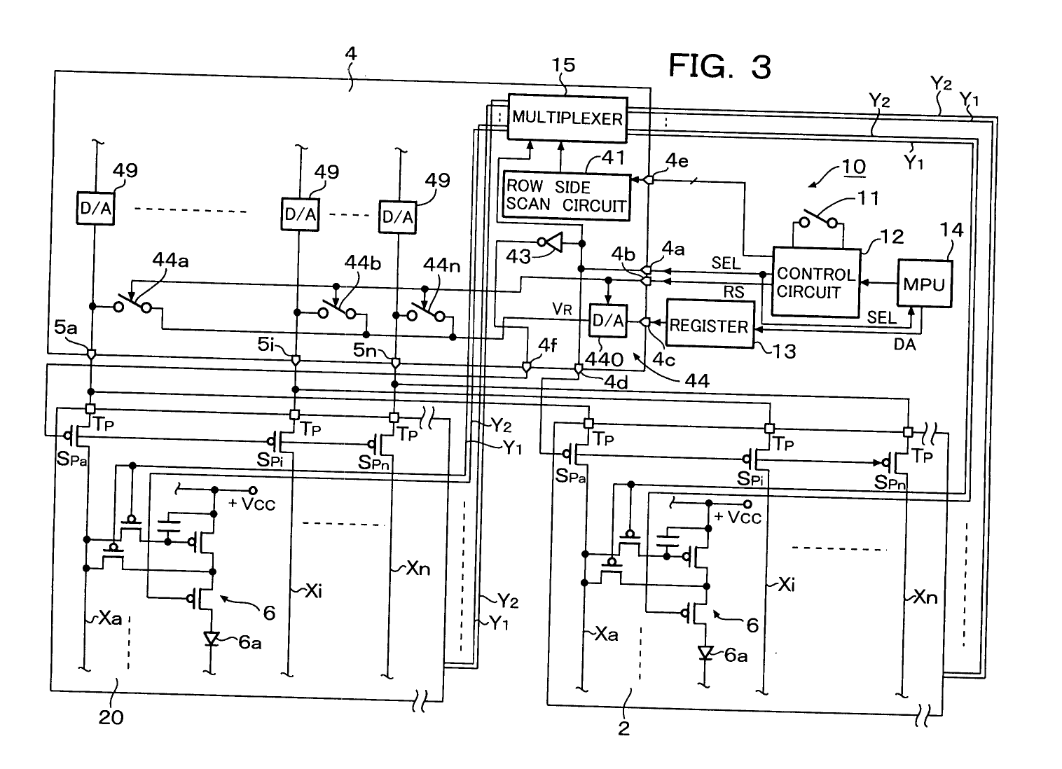

FIG. 4 is a block circuit diagram of a further embodiment of the organic EL display device of the present invention, in which a current drive circuit is commonly used by two active matrix type organic EL panels.

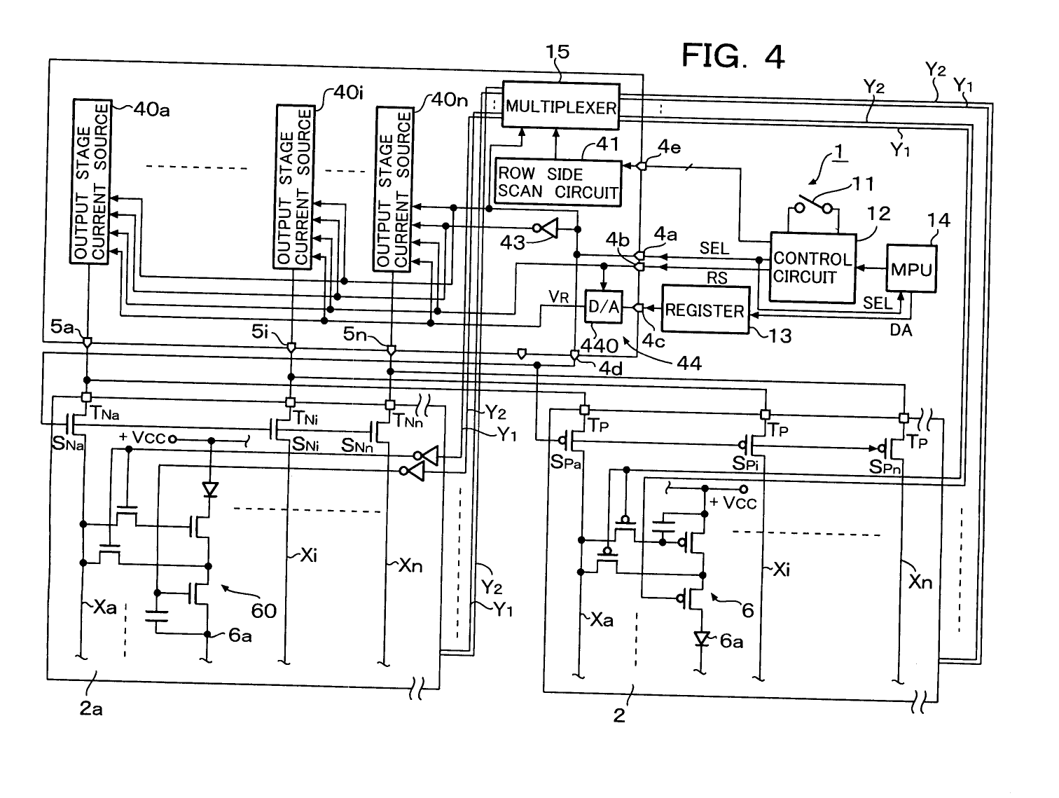

### DESCRIPTION OF REFERENCE NUMERALS AND SIGNS

1 . . . organic EL display device
2 2a, 20 . . . organic EL panel of the active matrix type
3 . . . organic EL panel of the passive matrix type
3a, 6a . . . organic EL element (OEL element)
4 . . . driver IC
40,40a˜40n . . . output stage current source
5 . . . output pin, 6,60 . . . pixel circuit,
7,8 . . . row line
11 . . . display switch
12 . . . control circuit
13 . . . register, 14 . . . MPU, 15 . . . multiplexer
41,42 . . . row side scan circuit
440,49 . . . D/A converter circuit (D/A)
43 . . . inverter, 44 . . . reset circuit
44a, 44x, 44n, 46, 47, 48 . . . analog switch
45 . . . current mirror circuit

1. An organic EL display device for selectively driving one of two organic EL panels according to a selection signal to perform a predetermined display, comprising:
a first organic EL panel of the active matrix type;
a second organic EL panel of the passive or active matrix type;
a plurality of current drive circuits having output pins commonly connected to data lines or column pins of said first organic EL panel and said second organic EL display panels, for outputting drive currents for driving organic EL elements to said data lines or said column pins connected to said output pins;
a plurality of first switch circuits provided in connecting lines to said data lines or said column pins of said first organic EL display panel for cutting the drive currents off, respectively; and
a drive current cutoff circuit provided within said second organic EL panel or downstream of said organic EL elements of said second organic EL panel, for cutting the drive currents supplied to said second organic EL panel off,
wherein said first switch circuits are turned OFF when said second organic EL panel is driven according to the selection signal, to cut the drive currents to said first organic EL panel off and output the drive currents to said data lines or said column pins of said second organic EL panel and said drive current cutoff circuit cuts the drive currents to said second organic EL panel off and said first switch circuits are turned ON, when said first organic EL panel is driven according to the selection signal, to output the drive currents to said data lines or said column pins of said first organic EL panel.

2. The organic EL display device as claimed in claim 1, wherein said drive current cutoff circuits are constructed with scan circuits provided to said first and second organic EL panels, respectively, for scanning scan lines to be scanned in a row direction or a vertical direction of said first and second organic EL panels, one of said scan circuits, which corresponds to either one of said first and second organic EL panels, is actuated according to the selection signal to discharge the drive currents and to cut the drive currents flowing to the other organic EL panel off by stopping the scanning operation of said scan circuit of the other organic EL panel or the operation of said scan circuit itself to thereby operate said scan circuit of said the other organic EL panel as said drive current cutoff circuit.

3. The organic EL display device as claimed in claim 2, wherein the scanning operation of said scan circuit, which corresponds to either one of said first and second organic EL panels, is started at a time when or after the scanning operation of said scan circuit of said the other organic EL panel or the operation of said circuit of said the other organic EL panel itself is stopped.

4. The organic EL display device as claimed in claim 2, further comprising a reset circuit for resetting terminal voltages of said organic EL elements or said capacitors of said pixel circuits, wherein said reset circuit has a D/A converter circuit and a plurality of analog switches connected to said output pins, externally supplied data are converted into an analog voltage by said D/A converter circuit and the analog voltage is outputted as the reset voltages when said analog switches are turned ON in a reset period.

5. The organic EL display device as claimed in claim 4, wherein said second organic EL panel is of the passive matrix type.

6. The organic EL display device as claimed in claim 4, wherein said second organic EL panel is of the active matrix type and said scan circuit of said first organic EL panel is used as said scan circuit of said second organic EL panel and wherein said drive current cutoff circuits are a plurality of second switch circuits for cutting the drive currents outputted to said data lines or said column pins off, respectively, when said second switch circuits are turned OFF, said second switch circuits being turned ON when said second organic EL panel is driven according to the selection signal to flow the drive currents to said data lines or said column pins of said second organic EL panel and said second switch circuits are turned OFF when said first organic EL panel is driven according to the selection signal.

7. The organic EL display device as claimed in claim 5, wherein either one of said first and second organic EL panels is driven when source currents are outputted to said output pins and the other organic EL panel is driven when sink currents are outputted to said output pins and wherein said current drive circuits generate the source currents or the sink currents according to the selection signal.

8. The organic EL display device as claimed in claim 7, further comprising switch means adapted to be ON/OFF controlled according to an opening and closing of a flap cover of a device having said organic EL display device, wherein one of said first and second organic EL panels is a main display and the other organic EL panel is a sub display and the selection signal is generated according to ON/OFF operation of said switch means.

9. The organic EL display device as claimed in claim 8, wherein said switch means is ON/OFF controlled according to a signal from an optical sensor provided in said device.

10. An organic EL display device for selectively driving one of two organic EL panels according to a selection signal to perform a predetermined display, comprising:
a first organic EL panel and a second organic EL panel, having different reset voltages;
a plurality of current drive circuits having output pins commonly connected to data lines or column pins of said first organic EL panel and said second organic EL display panel, for outputting drive currents of organic EL elements of said first and second organic EL panels to said data lines or said column pins connected to said output pins; and
a reset circuit having a D/A converter circuit and a plurality of analog switches, for resetting terminal voltages of said organic EL elements or capacitors of pixel circuits,
wherein said reset circuit converts externally supplied data into an analog voltage by said D/A converter circuit and output the analog voltage as the reset voltage when said analog switches are turned ON during a reset period.

11. The organic EL display device as claimed in claim 10, wherein said first organic EL panel is of the active matrix type, said second organic EL panel is of the passive matrix type, the externally supplied data includes a first data for resetting the terminal voltages of said capacitors of said pixel circuits and a second data for resetting terminal voltages of said organic EL elements and one of the first data and the second data is selectively supplied to said D/A converter circuit according to the selection signal.

12. The organic EL display device as claimed in claim 11, further comprising switch means adapted to be ON/OFF controlled according to an opening and a closing of a flap cover of a device having said organic EL display device therein, wherein one of said first and second organic EL panels is a main display and the other organic EL panel is a sub display and the selection signal is generated according to ON/OFF operation of said switch means.
